(19) United States
(12) Patent Application Publication
(10) Pub. No.: US 2013/0114491 A1
(43) Pub. Date: May 9, 2013

(54) Medium Access Control Enhancements

(71) Applicants: Taejoon Kim, Berkeley, CA (US); Sayantan Choudhury, Berkeley, CA (US); Zhong-Yi Jin, Albany, CA (US); Klaus F. Doppler, Albany, CA (US); Chittabrata Ghosh, Union City, CA (US); Hongkun Li, Berkeley, CA (US)

(72) Inventors: Taejoon Kim, Berkeley, CA (US); Sayantan Choudhury, Berkeley, CA (US); Zhong-Yi Jin, Albany, CA (US); Klaus F. Doppler, Albany, CA (US); Chittabrata Ghosh, Union City, CA (US); Hongkun Li, Berkeley, CA (US)

(73) Assignee: Nokia Corporation

(21) Appl. No.: 13/289,332

(22) Filed: Nov. 4, 2011

(51) Int. Cl. H04W 72/04

(52) U.S. Cl. 370/312

(57) ABSTRACT

The exemplary embodiments enable setting one or more devices of a wireless communication network to be associated with a one or more groups of a plurality of groups based on at least a device type of the one or more devices, receiving at least one indication that one or more devices have data to send, and allocating, one group at a time, resources to the groups associated with the devices with data to send. Further, receiving a probe message from a network node, the probe message identifying one or more groups set to the device based at least on a device type, sending, information to the node, the information providing an indication that data is required to be sent, and in response to the sending, receiving a resource allocation from the node to send the data, wherein the resource allocation is arranged based on the groups set to the device.

### TECHNICAL FIELD

The teachings in accordance with the exemplary embodiments of this invention relate generally to a method to provide enhanced implementations for communications in a network, such as a wireless network and, more specifically, relate to a method and apparatus to provide medium access control enhancements in the network.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:

ACK acknowledgement
AP access point
AUC authentication center
CP cyclic prefix
CRC cyclic redundancy check
DFT discrete Fourier transform
FFT fast fourier transform
GI guard interval
MAC medium access control
MCC mobile country code
MCN mobile network code
ML maximum likelihood
MNO mobile network operator
MU macro urban
OFDM orthogonal frequency domain multiplex
PCF point coordination function
PP-MAC probe and pull medium access control
PHY ACK physical layer acknowledgement
QoS quality of service
SCM spatial channel module
SIFS short interference space
SNR signal to noise ratio
STA station
VLR visitor location register
VNO visitor location register
WLAN wireless local area network

The MAC layer is a sub layer of the data link layer as specified in the seven-layer OSI model (layer 2) and the four-layer TCP/IP model (layer 1). The data link layer provides addressing and channel access control mechanisms that make it possible for multiple terminals or network nodes to communicate within a multiple access network that incorporates a shared medium, such as the WLAN. The exemplary embodiments of the invention address shortfalls of at least some MAC layer implementation issues in networks, such as wireless local area networks (WLAN).

### SUMMARY

In an exemplary aspect of the invention, there is a method comprising setting, by a network node, one or more devices of a wireless communication network to be associated with a one or more groups of a plurality of groups based on at least a device type of the one or more devices, receiving at least one indication that the one or more devices has data to send in the wireless communication network, and allocating, one group at a time, a resource to the one or more groups associated with one or more devices with data to send.

In an exemplary embodiment of the invention, there is an apparatus comprising at least one processor, and at least one memory including computer program code, where the at least one memory and the computer program code are configured, with the at least one processor, to cause the apparatus to at least set, at a network node, one or more devices of a wireless communication network to be associated with a one or more groups of a plurality of groups based on at least a device type of the one or more devices, receive at least one indication that the one or more devices has data to send in the wireless communication network, and allocate, one group at a time, a resource to the one or more groups associated with one or more devices with data to send.

In an exemplary embodiment of the invention, there is an apparatus comprising a means for setting, at a network node, one or more devices of a wireless communication network to be associated with a one or more groups of a plurality of groups based on at least a device type of the one or more devices, a means for receiving at least one indication that the one or more devices has data to send in the wireless communication network, and a means for allocating, one group at a time, a resource to the one or more groups associated with one or more devices with data to send.

In another exemplary aspect of the invention, there is a method comprising receiving, at a device of a wireless communication network, a probe message from a network node of the wire communication network, the probe message identifying one or more groups set to the device based at least on a device type of the device, sending, by the device, information to the network node of the wireless communication network, the information providing an indication that data is required to be sent by the device, and in response to the sending, receiving a resource allocation from the network node in order to send the data, wherein the resource allocation is arranged based on the one or more groups set to the device.

In another exemplary aspect of the invention, there is an apparatus comprising at least one processor, and at least one memory including computer program code, where the at least one memory and the computer program code are configured, with the at least one processor, to cause the apparatus to at least receive, at a device of a wireless communication network, a probe message from a network node of the wire communication network, the probe message identifying one or more groups set to the device based at least on a device type of the device, send, by the device, information to the network node of the wireless communication network, the information providing an indication that data is required to be sent by the device, and receive, in response to the sending, a resource allocation from the network node in order to send the data, wherein the resource allocation is arranged based on the one or more groups set to the device.

In yet another exemplary aspect of the invention, there is an apparatus comprising means for receiving, at a device of a wireless communication network, a probe message from a network node of the wire communication network, the probe message identifying one or more groups set to the device based at least on a device type of the device, means for sending, by the device, information to the network node of the wireless communication network, the information providing an indication that data is required to be sent by the device, and means, in response to the sending, for receiving a resource allocation from the network node in order to send the data, wherein the resource allocation is arranged based on the one or more groups set to the device.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 illustrates probe and pull medium access control operation;

FIG. 2 illustrates an ACK signal packet;

FIG. 3 illustrates a code domain approach, a time domain approach, and a time and code domain approach in accordance with the exemplary embodiments;

FIG. 4 illustrates a sequence ID and time offset table for sequences sent in accordance with the exemplary embodiments of the invention;

FIG. 5 illustrates a frame structure of an ACK packet in accordance with the exemplary embodiments of the invention;

FIGS. 6A and 6B illustrates a table showing predefined sequence Ids and time offsets in accordance with the exemplary embodiments of the invention;

FIG. 7 illustrates an OFDM training structure in 802.11;

FIG. 8 illustrates a multiuser detection model in accordance with the exemplary embodiments of the invention;

FIG. 9 illustrates a user detection probability graph, in accordance with the exemplary embodiments of the invention;

FIG. 10 illustrates a message format of a probe request, in accordance with the exemplary embodiments of the invention;

FIG. 11 is a simplified block diagram of various devices which are exemplary electronic devices suitable for use in practicing the exemplary embodiments of the invention; and

FIGS. 12 and 13 are logic flow diagrams that each illustrate the operation of a method, and a result of execution of computer program instructions embodied on a computer readable memory, in accordance with the exemplary embodiments of this invention.

### DETAILED DESCRIPTION

IEEE 802.11 standards are defined for implementing wireless local area network (WLAN) communications. The 802.11 standards were created by the IEEE LAN/MAN Standards Committee (IEEE 802). IEEE 802.11 identifies a series of over-the-air modulation techniques that use a similar basic protocol. Wi-Fi is a brand name for products using the IEEE 802.11 family of standards

An access point (AP) is a device that allows wireless devices to connect to a wired network using Wi-Fi or 802.11 standards. The AP usually connects to a router (via a wired network), and can relay data between the wireless devices (such as computers or printers) and wired devices of the network.

The 802.11 standard specifies a common medium access control (MAC) Layer, which provides a variety of functions that support the operation of 802.11-based WLANs. In general, the MAC Layer manages and maintains communications between 802.11 stations, mobile electronic devices and/or access points by coordinating the access with a shared radio channel and utilizing protocols that allow communications over the WLAN.

A point coordination function (PCF) is a medium access control layer scheme implemented in 802.11 transmissions where the access point (AP) sends CF-Poll messages to one user device at a time. One problem exists in the PCF implementation under 802.11 in that in response to a CF-Poll message from the access point, each user terminal may transmit its data after receiving the CF-Poll message/packet. In the event there is no data to be transmitted, the user terminal responds with a null frame (or no transmission). Hence, there is loss of channel utilization in the event a node is probed and has no data to transmit, thus making the protocol less efficient. In addition, data reported may only need to be reported infrequently to the AP. Thus, at least the null frame reporting methods, as implemented in the 802.11 WLAN as stated above, can be wasteful of energy.

The exemplary embodiments of the invention provide at least a method and apparatus to provide MAC layer enhancements in a Wi-Fi network. More particularly, the exemplary embodiments of the invention provide MAC layer enhancements in order to provide an improved ACK signaling implementation and provide improved energy efficient operations of devices using Wi-Fi communication.

The exemplary embodiments of the invention provide signal design methods to enhance Media Access Control (MAC) operations in an 802.11 network. The exemplary embodiments provide methods to enhance at least infrastructure and ad-hoc wireless networks which may consist of large numbers of devices, such as a large number of user devices and/or access points. Further, the exemplary embodiments of the invention provide a novel method to at least enable energy efficient operations of these devices. The exemplary embodiments provide a method to support radio level duty cycling, lower levels of latency within defined boundaries, increase throughput, increase bandwidth utilization, improve quality of service (QOS) for communications in a network and lessen path loss experienced by devices in the network.

In accordance with an exemplary embodiment of the invention a novel MAC layer implementation is provided. The proposed MAC layer implementation enables:

1) Sensor nodes/AP with up to 1 km direct wireless communication range (outdoor).
2) Up to 6000 sensor nodes in 1 network.
3) Bounded and low latency communication.
4) Reduced duty cycles of sensor nodes (<1%).
5) Higher data rates.
6) Higher bandwidth utilization.

### 7) Improved QOS.

8) Lessen path loss experienced.

The exemplary embodiments of the invention provide a method using a probe and pull medium access control (PP-MAC) to coordinate the transmissions from wireless devices in a Wi-Fi network. A feature element of the PP MAC is the possibility to send an acknowledgment (ACK) in parallel after a PROBE message/packet sent by a Wi-Fi AP.

In an example embodiment, the sensor nodes and/or devices may keep their wireless interfaces in a sleeping, inactive, or low-power state until they have data to send. While the sleeping, inactive, or low-power state may refer to the state of the wireless or radio interfaces, the sleeping, inactive, or low-power state may also refer to a state of other circuitry or modules within the nodes, such as baseband processors which may process, modulate, and/or demodulate data for transmitting and/or receiving by a wireless or radio interface. The devices, which may include sensor nodes, may, for example, monitor events while maintaining their wireless or radio interfaces in the inactive state. When a sensor node has data to send, the sensor node may transition its wireless interface (or other module) to an active state. In the active state, the sensor nodes/APs may listen for PROBE messages from the access point, which may initiate the sending of the recorded data from the sensor nodes to the access point.

The access point may also have a limited duty cycle, or may continually maintain its wireless interface in an active state. The access point may send PROBE messages to the sensor nodes periodically, and/or non-periodically and/or based on prompts from outside a network, such as outside a wireless network. The PROBE message may identify a group of sensor nodes, or may be broadcast. The sending of the PROBE message that identifies the group of sensor nodes may allow the access point to probe the sensor nodes in the group in parallel to determine which sensor nodes have data to transmit, how much data each sensor node needs to transmit, and the quality of service required for each sensor node's data transfer.

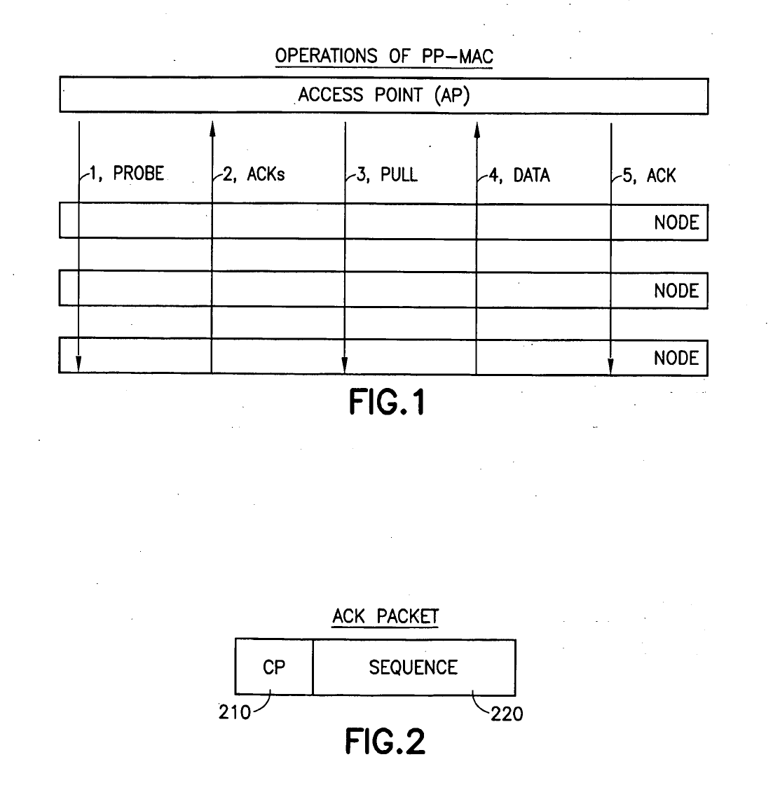

FIG. 1 illustrates an exemplary probe and pull medium access control (PP-MAC) sequence implementation between more than one device (i.e., sensor nodes) and an access point (AP) of a wireless communication network. The PP-MAC sequence implementation can be used to enable a device, such as an access point, to receive an ACK from each of the multiple devices of a wireless network and to detect which device each ACK came from.

A main challenge for the AP in FIG. 1 is to distinguish from the multiple ACKs which user device(s) want to transmit data at any given time. In order to do this, the AP must distinguish each of the poll responses of the multiple users. In some common deployments, it is possible to have 1000s of nodes (e.g., sensor applications) wanting to transmit concurrently. Considering the amount of poll responses of such a deployment the difficulty for the AP to distinguish each of the poll responses can be exceedingly difficult. An AP using a conventional MAC implementation would be required to use very long sequences of data and high computational complexity at least in order to distinguish poll responses.

In order to address at least the above described shortfalls the exemplary embodiments of the invention provide a method to categorize user devices into different groups with each group having its own group ID and each user device of the group having their own ID. Hence, each user can be identified by a group and/or a user id.

The grouping or user ID allocation can be performed arbitrarily or can be based on different factors such as the device category or a device type, quality of service requirement of each user device, and/or path loss between a user device and an AP when an association takes place. In an exemplary embodiment, all user devices within a group may be located on a particular ring and/or cell boundary and/or belong to the same device, same QoS category, and/or cluster. Grouping user devices placed within as same or similar distance from AP provides a simple way to overcome, for example, near-far problems in a multiple access scenario. Further, in accordance with the exemplary embodiments, the grouping can be based upon information that user device provided to an AP when the device was initially associated with a network for example. In addition, such information regarding a user device can include a device category and/or a device type, a QoS requirement for the device, and/or other information associated with the device.

Further, in accordance with the exemplary embodiments of the invention, the information can be provided/obtained using a link to a cloud service to get the parameters on how the sensor node should operate. Meanwhile, the AP measures channel quality using preambles and pilots presented in the association packet, and estimates path loss between an AP and an STA which also can be used to formulate user device groupings. Information regarding a group ID and/or user ID can be predefined for a user device and/or obtained from the user device when the user device was earlier and/or initially associated with a network for example. Such group ID and/or user ID information can be stored in a memory of a network device and/or stored in a database associated with the network and/or network device, and be accessible by the network device, such as an AP. Further, the group ID and/or user ID information (as well as sequence information) can be distributed to a user device using a PROBE message, as illustrated in FIG. 1. Further, in accordance with the exemplary embodiments of the invention, obtaining the Information regarding a group ID and/or user ID of a user device, as well as providing the sequence information for a user device, can be performed simultaneously using a PROBE message.

In accordance with another exemplary embodiment of the invention, a PP-MAC packet can be implemented in order to enable a device, such as an AP, to probe multiple user devices at a time. Then, based on responses to the PROBE messages, the AP can schedule only those user devices that have data to transmit. To achieve this novel implementation the AP is enabled to resolve ACK responses to the PROBE messages from multiple user devices in order to identify the user device from which a particular ACK was received.

In accordance with an exemplary embodiment of the invention, user devices in a Wi-Fi network are partitioned into groups and subgroups based on various factors using information regarding each of the user devices. Then the user devices as partitioned are assigned to specific sequences which are used to resolve the user devices within a user group. The grouping or partitioning can be performed based on a user ID or can be performed, for example, arbitrarily or based on different factors such as the device category and/or device type, quality of service requirement of each user, and/or path loss between user and AP when the association takes place.

In accordance with an exemplary embodiment of the invention, all user devices can be grouped according to a location on a ring and/or cell boundary and/or based on their association with a similar device. Further, user devices can be grouped according to a service level agreement with an operator, and/or based on their QoS requirements, and/or based on the device location, such as the location being near or far away with regards to another device. Grouping user devices located a same (or similar) distance from an AP can be an easier way to overcome problems, for example near-far problems associated with a multiple access scenario The grouping can be performed using information that a user device has provided to an AP, such information can include as a device category, and/or a device type and/or device QoS, information. Such information can be obtained from the user device when the user device was early and/or initially associated with the network for example. Further, in accordance with the exemplary embodiments, the information can be obtained over a link to a cloud service to get the parameters on how the sensor node should operate. Meanwhile, the AP measures the channel using preambles and pilots presented in the association packet and estimates path loss between the AP and a STA which also can be used for grouping users. The group ID and/or user ID (or sequence information) can also be distributed to the devices, in parallel, using a PROBE message, as in FIG. 1.

In accordance with the exemplary embodiments of the invention, there are novel mechanisms provided which enable a network device, such as an AP, to assign sequences to the different groups and user devices. While the sequences described with respect to the invention may be described as Zadoff Chu sequences, the exemplary embodiments of the invention can be used with other orthogonal codes and/or sequences as well. For the case where Zadoff-Chu sequences are used, each group could be identified by a different root sequence and users within the group uses different cyclic shifts of the root sequence. In this manner, different groups with different device categories and/or device types, QoS, and/or cluster can be distinguished based on the root sequence.

In regards to FIG. 2, a basic structure of an ACK packet 200 is illustrated. The structure of the ACK packet includes a cyclic prefix (CP) header 210 and a sequence 220. The ACK packet is used in either a time domain and a frequency domain network implemenation.

The ACK signal could be based on sequences with good auto-correlation and cross-correlation properties. A non-limiting example of such a sequences is, as stated above, a Zadoff-Chu sequence. In addition, in accordance with the exemplary embodiments of the invention, other sequences such as a generalized chirp-like polyphase sequence, to name only one, can be used. In one methodology, multiple user devices can transmit concurrently using different pre-assigned sequences that are orthogonal (or semi-orthogonal) to each other. The sequences are typically assigned during the association phase of the station with the access point and the assignment is only changed occasionally, such as when a new STA joins the network.

In the case of multiple device categories and/or device types and/or QoS requirements of user devices within a particular group, a sequence set could be partitioned based on QoS and/or device categories and/or device types associated with user devices of the group. For example, a higher priority user can use a different root sequence than those used by a lower priority user. Alternatively, a higher priority user could use a longer (or shorter) sequence length as compared to a lower priority user. Then, without changing preamble structure, as may be the case in a WiFi communication, shorter sequences can be mapped and/or allocated to short-preambles for lower priority user devices, while longer sequences can be mapped/allocated to long-preambles to support higher priority user devices. However, it is noted that this mapping is non-limiting and, accordance with the exemplary embodiments, shorter sequences can be mapped to longer preambles and/or higher priority users, and longer sequences can be mapped to lower priority user devices.

After decoding the acknowledgment messages, a network node, such as an access point may know which sensor nodes sent the acknowledgment messages and have data to send. The access point may send pull messages, or spectral allocation messages, to the sensor nodes that sent the acknowledgment messages indicating that they have data to send. The pull or spectral allocation messages may allocate spectral resources, such as frequency subcarriers and time slots, to each of the sensor nodes which have data to send. The sensor nodes may send their data using the allocated spectral resources. The access point may acknowledge receiving the data, and the sensor nodes may, upon receiving the respective acknowledgments from the access point, delete or dequeue the queued data.

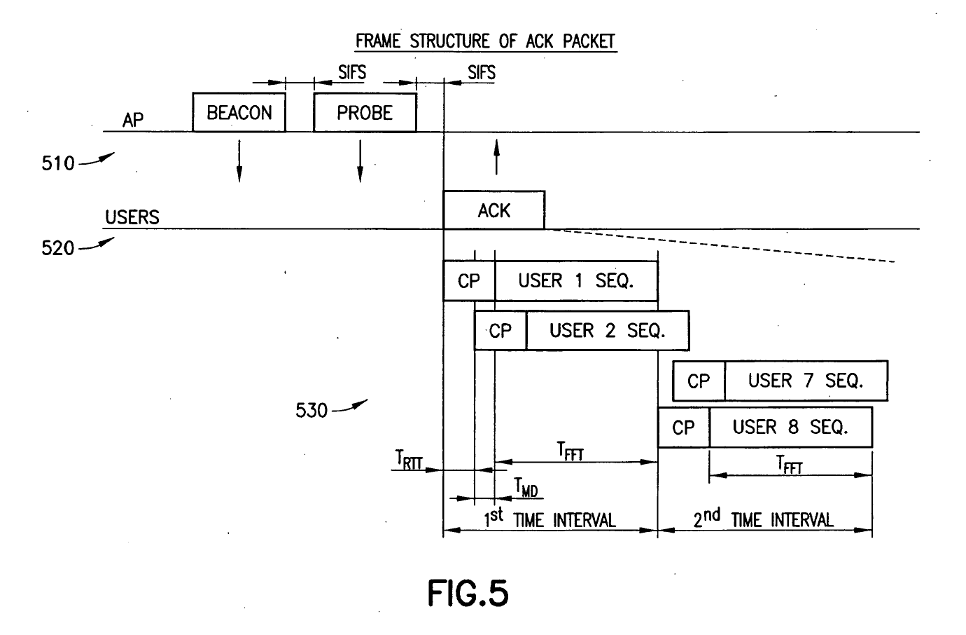

In accordance with the exemplary embodiments, the AP can also restrict the time at which certain sequences can be transmitted by user device(s) using a time domain and/or a code-domain approach. As mentioned earlier, the sequence and time offset allocation could be performed during an association phase or transmitted along with a PROBE message. FIG. 4 illustrates a table showing different time offsets for different sequence IDs. The time offset could also be interpreted as the amount of the cyclic shift to be applied to a root sequence, such as a Zadoff Chu sequence. In accordance with the exemplary embodiments, a user account, a symbol length and an FFT structure of WiFi symbols can be taken into account for a particular sequence design.

In addition, the orthogonality between sequences of two or more user devices could be in the code domain and/or the time domain. In the code-domain only approach, different user devices transmit sequences that are orthogonal to each other. In the time-domain approach, different users transmit sequences at different time intervals. In the time and code-domain, the user devices could be separated both in the time and code domain.

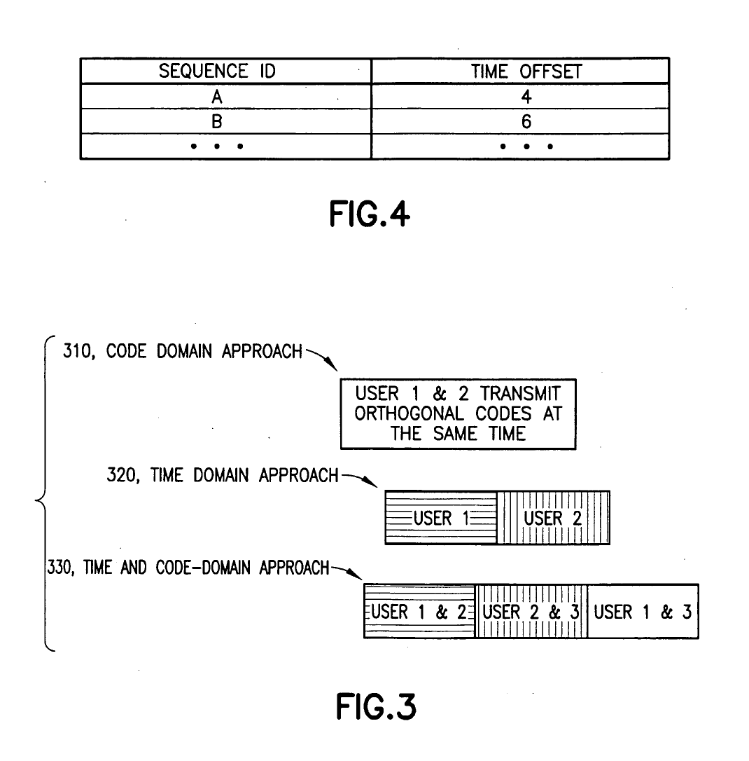

FIG. 3 illustrates transmit sequences of grouped user devices for a code domain approach 310, a time domain approach 320 as well as a time and code domain approach 330, as in accordance with an exemplary embodiment of the invention. In the code domain approach 310, user devices 1 and 2 transmit orthogonal codes at the same time in the same code domain. In the time domain approach 320 user device 1 transmits in a first code domain and user device 2 transmits in a second code domain. Whereas, in the time and code domain approach 330 user device 1 and 2 transmit at the same time in a first code domain, user devices 2 and 3 transmit at the same time in a next code domain, and then user devices 1 and 3 at the same time in another next code domain.

Note that with these three configurations, another domain, such as a frequency domain, can be added. The sequence length is determined by the round-trip delay, coverage requirements, number of user devices to be supported and overhead requirements. In addition, depending on the operating SNR and allowed time duration for ACK signaling, AP and user devices can coordinate to switch between two orthogonal approaches. For example, they can agree to switch between the code-domain approach and the time and code-domain approach.

Further, a set of sequences could also be categorized into different groups based on the amount of traffic allocation required by an user. For example, there could be different sets of sequence groups based on load such as:

Sequence Group 1: “High” traffic
Sequence Group 2: “Medium” traffic
Sequence Group 3: “Low” traffic

Hence, based on the poll response of any user, the access point not only knows which user device(s) has traffic to send it is also enabled to estimate an amount of traffic allocation that will be required by a user device. The access point in its PROBE message could also restrict user responses based on the amount of traffic it has to send, such as to send the probe to user devices only with “Low” amounts of traffic to send. Such grouping could be done based on using different root sequences for different groups or different cyclic shifts for a given group. Hence, the sequences implicitly carry some information about the traffic load. Further, in accordance with the exemplary embodiments of the invention, the classification of the high, medium and low traffic requirements can be predetermined and/or configured by a user, a network administrator, and/or a manufacturer of a device, such as an AP.

The following description will provide an even more detailed disclosure of the invention. In particular, it will be described how at least the above mechanisms can be implemented for a transmission, such as an OFDM transmission. Conventional WiFi mechanisms cannot distinguish concurrent poll responses from multiple users, as in accordance with the exemplary embodiments.

In this exemplary implementation, it can be assumed a 64 bit FFT size in 2 MHz bandwidth supported by IEEE 802.11ah for example. With this specification, subcarrier spacing is determined by 31.25 KHz resulting in T_{FFT}=32 us of FFT-time window. The OFDM symbol and packet structure must be determined based on the maximum round-trip time delay (maximum coverage requirements), maximum multipath spreading, synchronization and channel estimation requirements, and overhead requirements.

FIG. 5 illustrates a frame structure of an ACK packet in accordance with the exemplary embodiments of the invention. As illustrated in FIG. 5, the response to a PROBE message from the AP 510 can be transmitted by the user device 520 in a time-aligned manner as shown in FIG. 5. Each user device 520 transmits concurrently just after the PROBE message is received. As shown in 530 of FIG. 5, in order to avoid inter symbol interference and maintain continuity of the OFDM symbol, the CP length (T_{CP}) must be greater than T_{RTT}+T_{MD}, where T_{RTT} and T_{MD} denote the maximum round-trip time and maximum multipath delay, respectively. After the PROBE message followed by SIFS, the start of FFT window at AP is taken periodically with T_{RTT}+T_{MD} separation. As can be seen from FIG. 5, as long as T_{CP} is greater than T_{RTT}+T_{MD}, multiplexed symbols from different user devices are secured from inter-symbol interference due to multipath delay and maintain continuity within sequences. In this particular application, a guard interval (GI) can be omitted from the sequence structure. For the sensor nodes/AP application in 802.11 ah with distance up to 1 km, T_{RTT}=6 us and T_{MD}=2 us can be set to result in T_{CP}=12 us>6 us+2 us with some margin Please note that this is a longer CP compared to regular 802.11 ah transmissions (8 us). Notice that the start of FFT window can be placed between T_{RTT}+T_{MD} and T_{CP}.

PROBE messages can be transmitted after the Wi-Fi beacon and at regular intervals between beacons. PROBE message contains the group ID and optional the user IDs in the group and/or for a subgroup of the group to be probed in the current frame. FIG. 5 specifically depicts the time and code-domain approach.

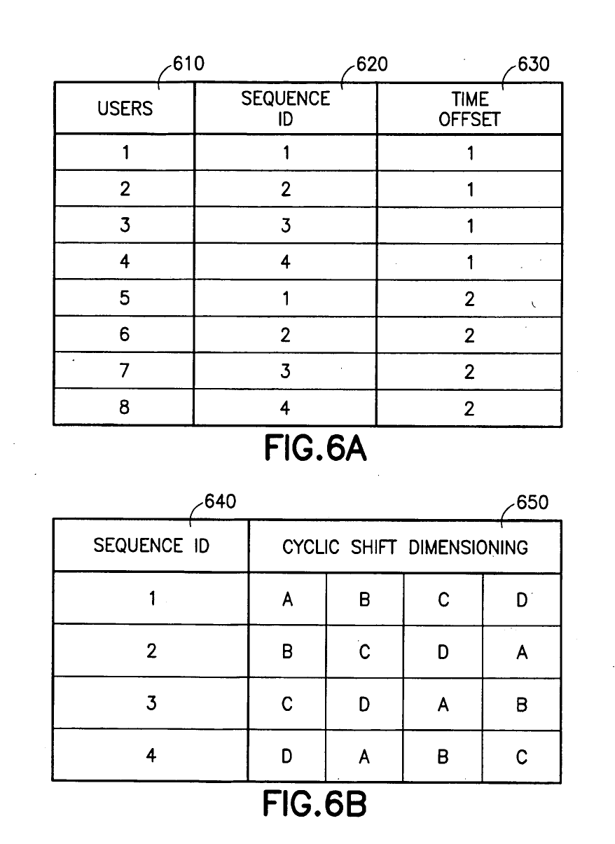

FIG. 6A illustrates a table which identifies offset settings 620 and sequence Ids 630 for user devices 610 of a time and code-domain approach time, as illustrated in FIG. 5. It can be seen that four users among the eight users 610 who have data to send and have transmitted ACK messages with different time offsets than the remaining other four user devices. It is noted that the eight user devices can form a single group or be a subgroup of the single group. In accordance with the exemplary embodiments, the time offsets and sequences could be pre-defined during the association phase or transmitted during the PROBE message.

For example, in a time and code domain implementation, the sequences are designed as Zadoff-Chu (ZC) sequences with different roots and different cyclic shifts. The ZC sequence is given by

$${Z}_{q} ( n ) = {e}^{( - j 2 π q \frac{\frac{n ( n + 1 )}{2}}{{N}_{zc}} )} , n = 0 , … , {N}_{zc} - 1 , q = 1 , … , {N}_{zc} - 1$$

Where Zq is a ZC sequence, where j is an index and where N_{zc} and q denote the length of sequence and the root of the sequence, respectively.

In order to maintain an optimal cyclic cross-correlation property, N_{zc} must be chosen as a prime number. Since the DFT of a ZC sequence is a weighted cyclically-shifted ZC sequence, the sequence can be generated in the time domain or frequency domain by maintaining the desired ZC property. In this implementation, the sequence is generated in a frequency domain. Given a 64 bit FFT size in 2 MHz bandwidth, 802.11 ah specifies to use 56 subcarriers with nulling the rest of 8 subcarriers (including d.c. subcarrier) to meet the spectrum mask. The largest prime number smaller than 56 is N_{zc}=53. Four ZC sequences can be used for time offset 1 and 2, as in FIG. 6. Four different ZC sequences can be obtained by:

a) Cyclically shifting a single root sequence.
b) Directly generating four sequences with four different roots.

For cyclically shifting the single root sequence, as indicated above, the minimum value of the cyclic shift should be the smallest integer that is greater than the number of samples corresponding to Tim which equals 12 in our example. With 13 cyclic shifts the length 53 sequence Z_{q}(0:52) can be denoted as ABCD where A=Z_{q}(0:12), B=Z_{q}(13:25), C=Z_{q}(26:38), and D=Z_{q}(39:52). Thus, four cyclically shifted sequences can be generated, as shown in FIG. 6.

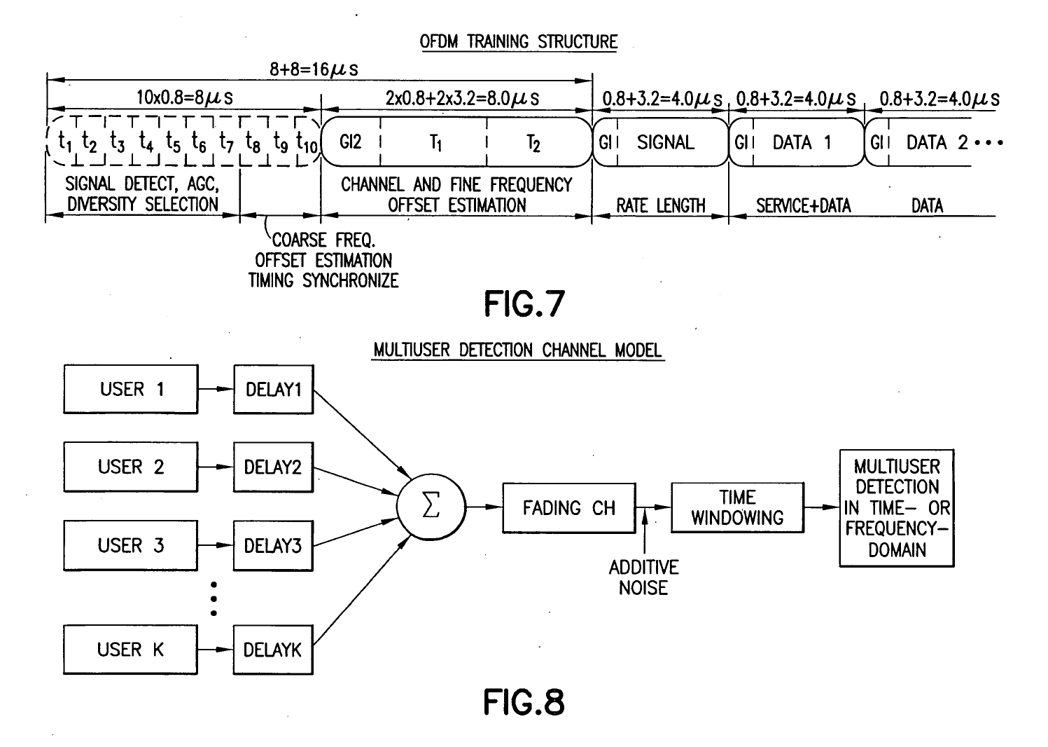

For directly generating the four sequences, as indicated above, four distinct ZC sequences Z_{q1}, Z_{q2}, Z_{q3}, Z_{q4} with qi≠qj for i≠j can be used. In addition, several ZC sequences can also be used by mixing the former and latter sequences. After IFFT of ZC sequences and adding CP, total 20+64 samples which correspond to one time interval, i.e., T_{CP}+T_{FFT}=44 us, are generated. The OFDM training structure in 802.11 consists of 10 short preambles and 2 long preambles 710 as illustrated in FIG. 7. FIG. 7 illustrates an OFDM training structure, as in 802.11.

The short OFDM training symbol consists of 12 subcarriers while the long consists of 53 symbols including 1 for the DC symbol. In accordance with an exemplary embodiment of the invention, there is a multiuser poll mechanism which can re-use the WLAN preamble structure with the short symbols being used for certain users and the longer for a different user class. For instance, more users could use the shorter symbols while fewer are reserved for the longer preambles or vice-versa.

It is noted that the symbol duration according to IEEE 802.11 ah is a 10 times down clocked version of the legacy 802.11, such that a T_{FFT}=32 us for 2 MHz bandwidth in 802.11 ah is down clocked to T_{FFT}=3.2 us for 20 MHz bandwidth. Thus, WLAN preamble structure could be easily re-used with simple clock scaling. In the shorter symbols, the sequence of a user could span the entire duration of short training symbols (8 us as in FIG. 7) and different users use different cyclic shifts while choosing their sequences.

Alternatively, different users could be reserved in different short symbols using time and code-domain approach, e.g., user 1 uses short symbol 1, 2, user 2 uses short symbol 2, 3 etc. In addition, more users can use long-preamble with code-domain approach. The symbols to be used for a particular user could be assigned during association with the access point. For an ACK signal, the rest of the message including the rate length, service and data may not need to be transmitted. In another exemplary embodiment, instead of using short and/or long preambles only short and/or long training symbols can be transmitted. Furthermore, the training symbols may or may not have a cyclic prefix.

Detection of multiplexed user sequences at a given time interval at AP can be done either by performing a correlation at a time domain with a different time offset and/or evaluating an inner product frequency domain, such as after a FFT, with a different phase rotation, i.e.,

$$q = {arg max }_{q} {max}_{m} \vert {\sum }_{n = 1}^{{N}_{fft}} {z}_{q}^{*} ( n ) y ( n + m ) \vert$$

$$or$$

$$q = {arg max }_{q} {max}_{l} \vert {\sum }_{n = 1}^{{N}_{fft}} {z}_{q}^{*} ( k ) Y ( k ) {e}^{j 2 π lk / {N}_{fft} } \vert$$

where y(n) (Y(k)) denotes the time (frequency) domain received signal captured during TFFT in FIG. 2 and z_{q}(n) (Z_{q}(k)) is the time (frequency) domain ZC sequence with root q.

FIG. 8 represents a multiuser detection channel model in our system. Each of delay values in FIG. 8 reflects different ACK arrival time, as modeled in FIG. 5, caused by the different distances between users and AP. In most of the cases, due to the near-far problem AP fails to detect all of the users correctly. To overcome this problem, user typically adapts transmit power so that the received power at AP aligned to the other users' received power. This can be done by specifying the TX power of AP and target received power for the ACK messages at AP in the PROBE message.

In addition, the grouping strategy, in accordance with the exemplary embodiments, can help to reduce the near-far problem by arranging users with similar distance from AP or path loss. Further, the grouping strategy can rely on non-coherent detection since the channel knowledge at AP is unlikely available due to high level of interferences. Fundamentally, ML detection, which compares all possible sequence combinations, is the optimal user detector which can be NP-hard or known in general. Sub-optimally, user detection can be done by comparing to a threshold, (i.e., slicing). If the correlation value between the received signal and i^{th} user sequence is above threshold AP declares user i detected, otherwise, AP declares no user i detected. Depending on an operational SNR, fading channel condition, and/or a number of maximum users to be supported the threshold value can be optimally adapted.

To examine the multiuser detection capability, a Monte Carlo simulation with a SCM Macro Urban (MU) multipath channel fading model is performed. As specified above, 53 length ZC sequences are used. In this simulation, time and code domain approach is designed for 10-10-10 structure, i.e., maximum 10 sequences are multiplexed in each of 4 time intervals (i.e., 44 us×4=168 us). In our simulation, one sample time corresponds to 0.5 us and in SCM MU model, RMS delay spread is modeled as 0.65 us. Thus, the multipath channel is generated with two channel taps. Here, threshold-value adaptation is not performed; rather one hard threshold adaptation is performed for all SNRs, where the value is chosen to give reasonable performance at high SNR. FIG. 4 displays the user detection probability.

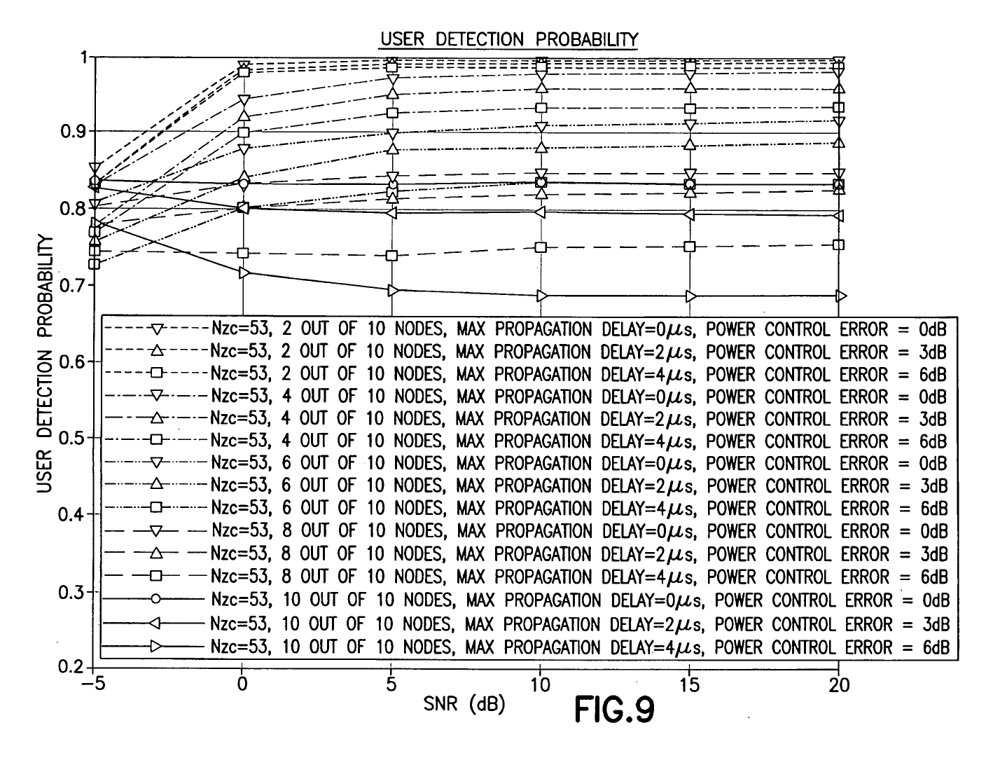

For instance, with regards to FIG. 9 a user device detection probability graph showing detection probabilities corresponding to different SNRs is illustrated. In FIG. 9, the graph lines which corresponding ‘2 out of 10 nodes’ implies correct user detection probability when two users concurrently sent ACK using two sequences among 10 possible sequences. The max propagation delay denotes the arrival time differences among ACKs from geographically spread users. For instance, 2 us delay and 4 us delay imply 333 m and 666 m distance differences between the nearest user and farthest user, respectively. The values for power control error, i.e., 0 dB, 3 dB, and 6 dB are chosen to evaluate impact on power adaptation error at users. For 2 and 4 users, the approach supports over 93% of user detection capability, and 6 and 8 user detection out of 10 users still supports over 80% accuracy. However, as can be seen from FIG. 9, for the 8 and 10 users out of 10 user cases interference is limiting the user detection probability. Please note that typically less than 10% of the users have data to transmit and even if the AP “only” detects 5 out of 6 users, the non-detected 6^{th} user can send another ACK after the next probe.

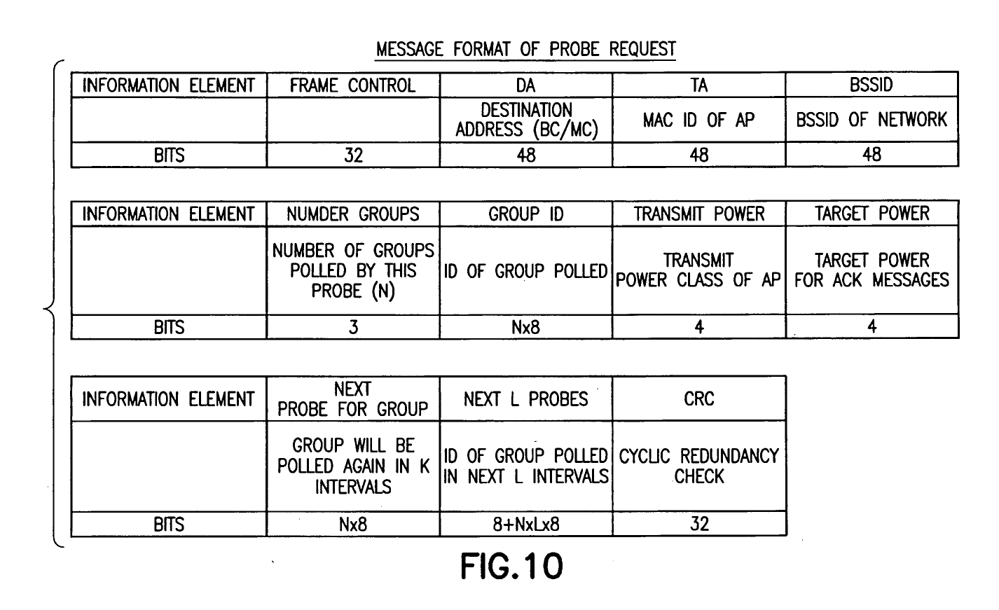

In regards to FIG. 10, there is illustrated a message format of the probe request, in accordance with the exemplary embodiments of the invention. The group ID specifies the ID of the group to be polled. It is noted that 802.11 ah requires up to 6000 STA which can be grouped for example in 100 groups of 60 STA. Optional N groups can be polled or probed with one probe message. In this case the PROBE message is followed by NACK periods for each group. The order is determined by the order of appearance in the PROBE message. Instead of including N group IDs this information element can be replaced by a bitmap with the size of the number of groups. An entry of one at the position of the group ID indicates that the group will be polled or probed by this PROBE message. The groups may be polled in ascending or descending order of their group ID.

The transmit power of the message format fields, as illustrated in FIG. 10, specifies a transmit power class of the AP. Here, a 4 bit field can distinguish 32 classes. The target power specifies the target received power for the ACK messages relative to the power class of the AP. This enables a simple form of power control which is needed to receive the ACK of all STA within for example 15 to 20 dB relative received power. If the power difference is greater than that, the detection of the ACK from different STA will be unreliable. Without power control the ACK of STA furthest from the AP will not be detected if STA close to the AP send ACK as well.

The next information elements give more information to the STA when it will be polled next. The Next Probe for Group field specifies the interval when the same group will be polled next. This field is present for each polled group. With this information STA that still have data in the buffer after the probe and pull period know when to wake up for the next probe.

The Next L probe field specifies the group IDs polled by the next L PROBE messages. In this case it can be assumed that the same amount of groups will be polled by each of the next L PROBE messages. The first 3 bits specify N and the next 5 bits L. Then follow the group IDs polled by the next L PROBE messages. Instead of signaling each probe separately this information element can be replaced by a bitmap with the size of the number of groups. An entry of one at the position of the group ID indicates that the group will be polled by one of the next L PROBE messages. This information will help a STA that just woke up to determine if it will be probed in the next L PROBE messages. If it is not probed, the STA can go back to idle state for L probe intervals and then wake up to receive the next probe.

In another exemplary embodiment, the AP polls each group in pre-determined order. Let's assume the AP PROBE messages the groups in ascending order. If a STA of group 50 wakes up and group 5 is currently polled, it will go back to sleep state for 45 intervals to wake up for the next probe of its group. Further, the PROBE messages may be transmitted frequently such as in durations of milliseconds, for example every 20 ms, and in order to keep the number of bits low. In accordance with the exemplary embodiments of the invention, a PROBE message contains 75 bits when probing a single group and giving information about the group probed in the next 5 PROBE messages. This is very low compared to 176 bits of MAC header and CRC present in each MAC frame.

As can be seen from at least the description above, the exemplary embodiments of the invention can be used to the benefit of any device in a wireless and/or wired and/or combination of wired and wireless communication network. The exemplary embodiments of the invention, such as the PP MAC, provide significant improvements in terms of latency, throughput, bandwidth utilization, power utilization and QOS.

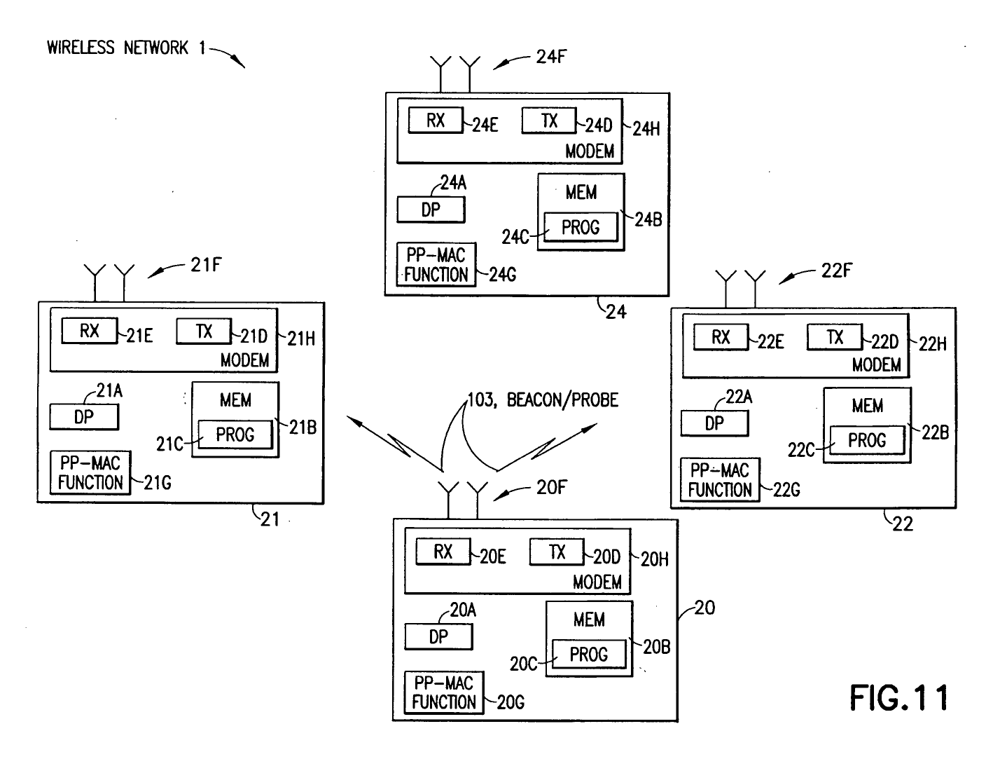

A reference is now made to FIG. 11 for illustrating a simplified block diagram of various electronic devices and apparatus that are suitable for use in practicing the exemplary embodiments of this invention. In FIG. 11 a network node 20 is adapted for communication over a wireless link (not specifically shown) with mobile apparatuses, such as mobile terminals, UEs or user devices 21, 22 and 24. The network node 20 can be a WLAN access point or any WiFi device enabled to operate in accordance with the exemplary embodiments of the invention as described above. The UEs or user devices 21, 22 and 24 can be any device in the wireless network 1 enabled to operate in accordance with the exemplary embodiments of the invention as described above. The network node 20 may be embodied in a network node of a communication network, such as embodied in a base station of a cellular network or another device of the cellular network. In one particular implementation, any of the user devices 21, 22 and 24 may be embodied as a WLAN station STA, either an access point station or a non-access point station, or may be incorporated in a cellular communication device.

The network node 20 includes processing means such as at least one data processor (DP) 20A, storing means such as at least one computer-readable memory (MEM) 20B storing at least one computer program (PROG) 20C, and also communicating means such as a transmitter TX 20D and a receiver RX 20E for bidirectional wireless communications with the user device 24 via one or more antennas 20F. The RX 20E and the TX 20D are each shown as being embodied with a modem 20H in a radio-frequency front end chip, which is one non-limiting embodiment; the modem 20H may be a physically separate but electrically coupled component. Further, the network node 20 incorporates a PP-MAC function 20G which is coupled to at least the DP 20A, the MEM 20B and the PROG 20C of the network node 20. The PP-MAC function 20G to be used with at least the MEM 20B and DP 20A to transmit the beacon frame/PROBE message 103, in accordance with the exemplary embodiments of the invention as at least described above

The user device 21 similarly includes processing means such as at least one data processor (DP) 21A, storing means such as at least one computer-readable memory (MEM) 21B storing at least one computer program (PROG) 21C, and communicating means such as a transmitter TX 21D and a receiver RX 21E and a modem 21H for bidirectional wireless communications with other apparatus of FIG. 11 via one or more antennas 21F. Using the PP-MAC function 21G, the user device 21 is at least enabled to perform the operations including at least processing the beacon frame/PROBE message 103 from the network node 20 in accordance with the exemplary embodiments of the invention, as described above.

Similarly, the user device 22 includes processing means such as at least one data processor (DP) 22A, storing means such as at least one computer-readable memory (MEM) 22B storing at least one computer program (PROG) 22C, and communicating means such as a modem 22H for bidirectional communication with the other devices of FIG. 6. Similar to the user device 21 the user device 22 is at least enabled, using the PP-MAC function 22G, to perform the operations including at least processing the beacon frame/PROBE message 103 from the network node 20, in accordance with the exemplary embodiments of the invention.

The user device 24 includes its own processing means such as at least one data processor (DP) 24A, storing means such as at least one computer-readable memory (MEM) 24B storing at least one computer program (PROG) 24C, and communicating means such as a transmitter TX 24D and a receiver RX 24E and a modem 24H for bidirectional wireless communications with devices 20, 21, 22 and 24 as detailed above via its antennas 24F. Thus, similar to the user devices 21 and 22 the user device 24 is at least enabled, using the PP-MAC function 24G, to perform the operations including at least processing the beacon frame/PROBE message 103 from the network node 20, in accordance with the exemplary embodiments of the invention. In addition, while the network node 20 and user devices 21, 22 and 24 are discussed with respect to the network node 20 acting as a centralized node, the disclosure included herein may also apply to mesh networks, in which any node may probe and pull data from other nodes, as can the network node 20.

At least one of the PROGs 20C, 21C, 22C and 24C in the respective network device 20, 21, 22 and 24 is assumed to include program instructions that, when executed by the associated DP 20A, 21A, 22A and 24A enable the respective device to operate in accordance with the exemplary embodiments of this invention, as detailed above. Blocks 20G, 21G, 22G and 24G summarize different results from executing different tangibly stored software to implement certain aspects of these teachings. In these regards the exemplary embodiments of this invention may be implemented at least in part by computer software stored on the MEM 20B, 21B, 22B and 24B which is executable by the DP 20A, 21A, 22A and 24A of the respective other devices 20, 21, 22 and 24 or by hardware, or by a combination of tangibly stored software and hardware (and tangibly stored firmware). Electronic devices implementing these aspects of the invention need not be the entire devices as depicted at FIG. 11, but exemplary embodiments may be implemented by one or more components of same such as the above described tangibly stored software, hardware, firmware and DP, or a system on a chip SOC or an application specific integrated circuit ASIC.

Various embodiments of the computer readable MEMs 20B, 21B, 22B and 24B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 21A, 22A and 24A include but are not limited to general purpose computers, special purpose computers, microprocessors, digital signal processors (DSPs) and multi-core processors.

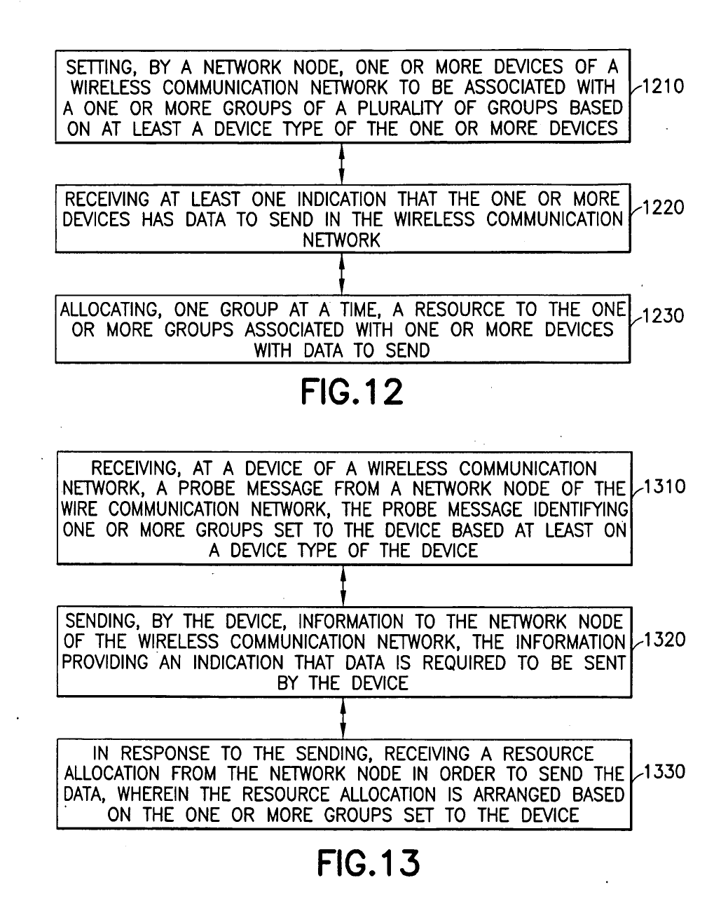

FIGS. 12 and 13 include block diagrams illustrating a method which may be implemented by an apparatus in accordance with the exemplary embodiments of the invention.

In regards to FIG. 12, at block 1210 there is setting, by a network node, one or more devices of a wireless communication network to be associated with a one or more groups of a plurality of groups based on at least a device type of the one or more devices. In block 1220 there is receiving at least one indication that the one or more devices has data to send in the wireless communication network. Then in block 1230 there is allocating, one group at a time, a resource to the one or more groups associated with one or more devices with data to send.

In accordance with the exemplary embodiments as described in the paragraph above, the groups are assigned to the device based on at least one of a service level agreement, a quality of service required and a path loss experienced for the one or more devices.

In accordance with the exemplary embodiments, as described in the paragraph above, the setting comprises receiving an indication of device identification from each one of the one or more devices.

Further, in accordance with the exemplary embodiments as described in the paragraphs above, the indication is received in response to a probe type message sent by the network node to the one or more devices.

In addition, in accordance with the exemplary embodiments as described in the paragraphs above, the indication is received in an acknowledgement message.

Further, in accordance with the exemplary embodiments as described in the paragraphs above, the indication comprises a sequence.

Further, in accordance with the exemplary embodiments as described in the paragraph above, the sequence is a Zadoff-Chu sequence.

In accordance with the exemplary embodiments as described in the paragraph above, the sequence identifies a size of the resource allocation needed to send the data.

In accordance with the exemplary embodiments as described in the paragraphs above, the wireless communication network is an orthogonal frequency division multiplexing network.

In accordance with the exemplary embodiments as described in the paragraphs above, there is receiving the at least one indication comprises using an orthogonal frequency division multiplexing training structure, the training structure comprising ten short preambles and two long preambles.

In accordance with the exemplary embodiments as described in the paragraph above, the short preambles are associated with different devices of the one or more devices and the long preambles are associated with different device types.

In addition, in accordance with an exemplary embodiment of the invention there is an apparatus comprising at least one processor, and at least one memory including computer program code, where the at least one memory and the computer program code are configured, with the at least one processor, to cause the apparatus to at least set, at a network node, one or more devices of a wireless communication network to be associated with a one or more groups of a plurality of groups based on at least a device type of the one or more devices, receive at least one indication that the one or more devices has data to send in the wireless communication network, and allocate, one group at a time, a resource to the one or more groups associated with one or more devices with data to send.

The apparatus, in accordance the exemplary embodiments of the invention as described in the paragraph above, wherein the groups are assigned to the device based on at least one of a service level agreement, a quality of service required and a path loss experienced for the one or more devices.

Further, in accordance with the exemplary embodiments as described in the paragraphs above, the setting comprises receiving an indication of device identification from each one of the one or more devices.

In accordance with the exemplary embodiments as described in the paragraph above wherein the indication is received in response to a probe type message sent by the network node to the one or more devices.

Further, in accordance with the exemplary embodiments as described in the paragraphs above the indication is received in an acknowledgement message.

The apparatus in accordance the exemplary embodiments of the invention as described in the paragraphs above, wherein the indication comprises a sequence.

The apparatus, in accordance the exemplary embodiments of the invention as described in the paragraph above, wherein the sequence is a Zadoff-Chu sequence.

In accordance the exemplary embodiments of the invention as described in the paragraphs above, the sequence comprises an indication of a size of the resource allocation needed by the each of the one or more devices to send its data.

The exemplary embodiments of the invention as described in the paragraph above, wherein the wireless communication network is an orthogonal frequency division multiplexing network.

In accordance with the exemplary embodiments as described in the paragraphs above, there is receiving the at least one indication comprises using an orthogonal frequency division multiplexing training structure, the training structure comprising ten short preambles and two long preambles.

In accordance with the exemplary embodiments as described in the paragraph above, the short preambles are associated with different devices of the one or more devices and the long preambles are associated with different device types.

Further, in accordance with an exemplary embodiment of the invention there is an apparatus comprising a means for setting, at a network node, one or more devices of a wireless communication network to be associated with a one or more groups of a plurality of groups based on at least a device type of the one or more devices, a means for receiving at least one indication that the one or more devices has data to send in the wireless communication network, and a means for allocating, one group at a time, a resource to the one or more groups associated with one or more devices with data to send.

The apparatus in accordance with the exemplary embodiment of the invention as described in the paragraph above, wherein the means for receiving comprises an interface to the wireless communication network, and the means for setting and allocating comprises at least one computer readable memory incluing at least one computer program, the at least one computer program executable by at least one processor.

In regards to FIG. 13, at block 1310 there is receiving, at a device of a wireless communication network, a probe message from a network node of the wire communication network, the probe message identifying one or more groups set to the device based at least on a device type of the device. Then at block 1320 there is sending, by the device, information to the network node of the wireless communication network, the information providing an indication that data is required to be sent by the device. Further, at block 1330 there is, in response to the sending, receiving a resource allocation from the network node in order to send the data, wherein the resource allocation is arranged based on the one or more groups set to the device.

In accordance with the exemplary embodiments as described in the paragraph above, the resource allocation is arranged to be received by the one or more groups set to the device one group at a time.

In accordance with the exemplary embodiments as described in the paragraph above, the one or more groups set to the device are set further based on at least one of a service level agreement, a quality of service required and a path loss experienced for the one or more devices.

In accordance with the exemplary embodiments as described in the paragraph above, the sending the information to the network node comprises sending an indication of an identification of the device.

Further, in accordance with the exemplary embodiments as described in the paragraphs above, the indication is sent in an acknowledgement message.

In accordance with the exemplary embodiments as described in the paragraph above, the indication comprises a sequence.

In accordance with the exemplary embodiments as described in the paragraph above, the sequence is a Zadoff-Chu sequence.

Additionally, in accordance with the exemplary embodiments as described in the paragraphs above, wherein the sequence comprises an indication of a size of the resource allocation needed by the each of the one or more devices to send its data.

In accordance with the exemplary embodiments as described in the paragraphs above, the wireless communication network is an orthogonal frequency division multiplexing network.

Further, in accordance with the exemplary embodiments of the invention there is an apparatus comprising at least one processor, and at least one memory including computer program code, where the at least one memory and the computer program code are configured, with the at least one processor, to cause the apparatus to at least receive, at a device of a wireless communication network, a probe message from a network node of the wire communication network, the probe message identifying one or more groups set to the device based at least on a device type of the device, send, by the device, information to the network node of the wireless communication network, the information providing an indication that data is required to be sent by the device, and receive, in response to the sending, a resource allocation from the network node in order to send the data, wherein the resource allocation is arranged based on the one or more groups set to the device.

The apparatus in accordance the exemplary embodiments of the invention as described in the paragraph above, wherein the resource allocation is arranged to be received by the one or more groups set to the device one group at a time.

The apparatus in accordance the exemplary embodiments of the invention as described in the paragraph above, wherein the one or more groups set to the device are set further based on at least one of a service level agreement, a quality of service required and a path loss experienced for the one or more devices.

The apparatus in accordance the exemplary embodiments of the invention as described in the paragraph above, wherein the sending the information to the network node comprises sending an indication of an identification of the device.

Further, in accordance with the exemplary embodiments of the invention as described in the paragraphs above the indication is sent in an acknowledgement message.

In accordance with the exemplary embodiments of the invention as described in the paragraph above, the indication is sent in an acknowledgement message, wherein the indication comprises a sequence.

In accordance with the exemplary embodiments of the invention as described in the paragraph above, the sequence is a Zadoff-Chu sequence.

In accordance with the exemplary embodiments of the invention as described in the paragraphs above, the sequence comprises an indication of a size of the resource allocation needed by the each of the one or more devices to send its data.

In accordance with the exemplary embodiments of the invention as described in the paragraphs above, the wireless communication network is an orthogonal frequency division multiplexing network.

In addition, in accordance with the exemplary embodiments of the invention there is an means for receiving, at a device of a wireless communication network, a probe message from a network node of the wire communication network, the probe message identifying one or more groups set to the device based at least on a device type of the device, means for sending, by the device, information to the network node of the wireless communication network, the information providing an indication that data is required to be sent by the device, and means, in response to the sending, for receiving a resource allocation from the network node in order to send the data, wherein the resource allocation is arranged based on the one or more groups set to the device.

Further, in accordance with exemplary apparatus as described in the paragraph above, the means for receiving and the means for sending comprises an interface to the wireless communication network.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1. A method comprising:
setting, by a network node, one or more devices of a wireless communication network to be associated with a one or more groups of a plurality of groups based on at least a device type of the one or more devices;
receiving at least one indication that the one or more devices has data to send in the wireless communication network; and
allocating, one group at a time, a resource to the one or more groups associated with one or more devices with data to send.

2. The method according to claim 1, wherein the groups are assigned to the device based on at least one of a service level agreement, a quality of service required and a path loss experienced for the one or more devices.

3. The method according to claim 1, wherein the setting the one or more devices comprises receiving an indication of device identification from each one of the one or more devices, wherein the indication is received in response to a probe type message sent by the network node to the one or more devices, wherein the indication is received in an acknowledgement message, and wherein the indication comprises a sequence, and wherein the probe type message is comprised of an indication of a group of the one or more groups to be polled next, an indication of when the group will be polled, an indication of a transmit power class of the network node, and an indication of a target receive power of the indication.

4. (canceled)

5. (canceled)

6. (canceled)

7. The method according to claim 3, wherein the sequence is a Zadoff-Chu sequence.

8. The method according to claim 3, wherein the sequence identifies a size of the resource allocation needed to send the data.

9. (canceled)

10. (canceled)

11. (canceled)

12. (canceled)

13. An apparatus comprising:
at least one processor; and
at least one memory including computer program code, where the at least one memory and the computer program code are configured, with the at least one processor, to cause the apparatus to at least:
set, at a network node, one or more devices of a wireless communication network to be associated with a one or more groups of a plurality of groups based on at least a device type of the one or more devices;
receive at least one indication that the one or more devices has data to send in the wireless communication network; and
allocate, one group at a time, a resource to the one or more groups associated with one or more devices with data to send.

14. The apparatus according to claim 13, wherein the groups are assigned to the device based on at least one of a service level agreement, a quality of service required and a path loss experienced for the one or more devices.

15. The apparatus according to claim 13, wherein the setting the one or more devices comprises receiving an indication of device identification from each one of the one or more devices, wherein the indication is received in response to a probe type message sent by the network node to the one or more devices, wherein the indication is received in an acknowledgement message, and wherein the indication comprises a sequence, and wherein the probe type message is comprised of an indication of a group of the one or more groups to be polled next, an indication of when the group will be polled, an indication of a transmit power class of the network node, and an indication of a target receive power of the indication.

16. (canceled)

17. (canceled)

18. (canceled)

19. The apparatus according to claim 15, wherein the sequence is a Zadoff-Chu sequence.

20. The apparatus according to claim 15, wherein the sequence comprises an indication of a size of the resource allocation needed by the each of the one or more devices to send its data.

21. (canceled)

22. (canceled)

23. (canceled)

24. (canceled)

25. (canceled)

26. A method comprising:
receiving, at a device of a wireless communication network, a probe message from a network node of the wire communication network, the probe message identifying one or more groups set to the device based at least on a device type of the device;
sending, by the device, information to the network node of the wireless communication network, the information providing an indication that data is required to be sent by the device; and
in response to the sending, receiving a resource allocation from the network node in order to send the data, wherein the resource allocation is arranged based on the one or more groups set to the device.

27. (canceled)

28. The method according to claim 26, wherein the one or more groups set to the device are set further based on at least one of a service level agreement, a quality of service required and a path loss experienced for the one or more devices.

29. The method according to claim 26, wherein the sending the information to the network node comprises sending an indication of an identification of the device, wherein the indication is sent in an acknowledgement message, and wherein the indication comprises a sequence.

30. (canceled)

31. (canceled)

32. The method according to claim 29, wherein the sequence is a Zadoff-Chu sequence.

33. The method according to claim 29, wherein the sequence comprises an indication of a size of the resource allocation needed by the each of the one or more devices to send its data.

34. The method according to claim 22, wherein the wireless communication network is an orthogonal frequency division multiplexing network.

35. (canceled)

36. An apparatus comprising:
at least one processor; and
at least one memory including computer program code, where the at least one memory and the computer program code are configured, with the at least one processor, to cause the apparatus to at least:
receive, at a device of a wireless communication network, a probe message from a network node of the wire communication network, the probe message identifying one or more groups set to the device based at least on a device type of the device;
send, by the device, information to the network node of the wireless communication network, the information providing an indication that data is required to be sent by the device; and
receive, in response to the sending, a resource allocation from the network node in order to send the data, wherein the resource allocation is arranged based on the one or more groups set to the device.

37. The apparatus according to claim 36, wherein the resource allocation is arranged to be received by the one or more groups set to the device one group at a time.

38. The apparatus according to claim 36, wherein the one or more groups set to the device are set further based on at least one of a service level agreement, a quality of service required and a path loss experienced for the one or more devices.

39. The apparatus according to claim 36, wherein the sending the information to the network node comprises sending an indication of an identification of the device, wherein the indication is sent in an acknowledgement message, and wherein the indication comprises a sequence.

40. (canceled)

41. (canceled)

42. The apparatus according to claim 39, wherein the sequence is a Zadoff-Chu sequence.

43. The apparatus according to claim 39, wherein the sequence comprises an indication of a size of the resource allocation needed by the each of the one or more devices to send its data.

44. The apparatus according to claim 36, wherein the wireless communication network is an orthogonal frequency division multiplexing network.

45. (canceled)

46. (canceled)
